(19) United States
(12) Patent Application Publication
(10) Pub. No.: US 2025/0119200 A1
(43) Pub. Date: Apr. 10, 2025

(54) SMART REPEATING IN RADIO NETWORKS

(71) Applicant: Nokia Technologies Oy, Espoo (FI)

(72) Inventors: Ilkka Antero KESKITALO, Oulu (FI); Shashika Manosha KAPURUHAMY BADALGE, Oulu (FI)

(21) Appl. No.: 18/687,544

(22) PCT Filed: Aug. 30, 2021
(86) PCT No.: PCT/EP2021/073881

§ 371 Date: Feb. 28, 2024

(51) Int. Cl. H04B 7/155

(52) U.S. Cl. CPC H04B 7/15528

(57) ABSTRACT

Inter-alia, a method is disclosed comprising: obtaining control information indicative of one or more control parameters for controlling a repeating of one or more signals of a cell of a serving node that is served by the first apparatus, wherein the control information is obtained from the serving node via a F1 interface established between a centralized unit, CU, of the serving node and a co-located distributed unit, DU, function on part of the first apparatus of a radio network; and repeating the one or more signals of the cell between a respective UE of one or more UEs served by the cell and the serving node based at least in part of the control information. It is further disclosed an according apparatus, computer program and system.

### FIELD

The following disclosure relates to the field of repeaters in radio networks, e.g. NR (New Radio) networks, or more particularly relates to systems, apparatuses, and methods for enhancing functionality of smart repeaters.

### BACKGROUND

A lower cost alternative to the usage of IAB (Integrated Access and Backhaul) for coverage extension are anticipated to be the RF (Radio Frequency) repeaters.

In 3GPP Rel. 17, basic repeater (RF) requirements are specified, where the actual repetition of signals is an A/F (amplify-and-forward) type with signal reception and transmission without decoding the signal. Hence, the received signal is just amplified in the transmitter power amplifier and fed to the TX (transmit) antenna panel. One of the main issue with such an A/F repeater is that it is amplifying everything it receives, including also noise and interfering signals it may receive, in addition to the amplification of the desired signal.

With features supported by 3GPP releases beyond Rel. 17, smart features for repeater operation may be enabled allowing support for NR (New Radio) features like dynamic TDD (Time Division Duplex), advanced power/gain control, beam management, or the like. Such features require advanced means to control the SR operation. However, it is open what is the control channel and on which layer the communication between the SR and a serving node would happen.

An assumed structure of SRs (smart repeaters) has UE/MT (user equipment/mobile termination) functionality that can monitor DL (Downlink) signals sent by the serving node. DL signals can be SSB (Synchronization Signal Block) for DL synchronization, system information to decode cell configurations, PDCCH (Physical Downlink Control channel) for RRC (Radio Resource Control), etc.

Without appropriate capability to receive control information,
the repeater cannot follow in real-time possible changes in the radio network, cell configurations, power levels of the TX signals, UE specific configuration and resource usage;
the repeater may not react to all the changes in the network deployment that can impact what the repeater is receiving and amplifying;
even though UE/MT (hosted by the SR) connected to the serving node could decode cell broadcast channels and could have RRC connection, not all required information is available in real-time at the repeater.

### SUMMARY OF SOME EXEMPLARY EMBODIMENTS

It is thus, inter alia, an object to achieve optimized SR operation, in particular enabling low cost repeating functionality while reducing or avoiding the known drawbacks. For instance, minimizing the amplification of interference(s) and/or noise, allowing to control amplification (e.g. only) for a desired signal or band, and enabling gain control to be adjusted are desired to be achieved.

According to a first exemplary aspect, a method is disclosed, the method comprising:
obtaining control information indicative of one or more control parameters for controlling a repeating of one or more signals of a cell of a serving node that is served by the first apparatus, wherein the control information is obtained from the serving node via a F1 interface established between a centralized unit, CU, of the serving node and a co-located distributed unit, DU, function on part of the first apparatus of a radio network; and
repeating the one or more signals of the cell between a respective UE of one or more UEs served by the cell and the serving node based at least in part of the control information.

This method may for instance be performed and/or controlled by an apparatus, for instance a repeater, e.g. a smart repeater. For instance, the method may be performed and/or controlled by using at least one processor of the smart repeater. The apparatus may for instance be part of a radio network.

According to a second exemplary aspect, a method is disclosed, the method comprising:
providing control information indicative of one or more control parameters for controlling a repeating of one or more signals of a cell of the second apparatus that is served by a smart repeater, SR, wherein the control information is provided via a F1 interface established between a centralized unit, CU, of the second apparatus and a co-located distributed unit, DU, function on part of the SR of a radio network; and
sending and/or receiving one or more signals of the cell to and/or from the SR.

This method may for instance be performed and/or controlled by an apparatus, for instance a serving node or a base station of a radio network, and/or a serving node or a base station (e.g. gNB, or en-gNB) hosting a CU component of the radio network. For instance, the method may be performed and/or controlled by using at least one processor of the serving node or the base station.

According to a third exemplary aspect, a method is disclosed, the method comprising:
obtaining (e.g. receiving), by a smart repeater, SR, of a radio network, control information indicative of one or more control parameters for controlling a repeating of one or more signals of a cell of a serving node of the radio network that is served by the SR, wherein the control information is obtained from the serving node via a F1 interface established between a centralized unit, CU, of the serving node and a co-located distributed unit, DU, function on part of the SR;
providing (e.g. sending), by the serving node, control information indicative of one or more control parameters for controlling a repeating of one or more signals of the cell of the serving node, wherein the control information is provided via the F1 interface; and
sending and/or receiving, by the serving node, one or more signals of the cell to and/or from the SR; and
repeating (e.g. amplifying and forwarding), by the SR, the one or more signals of the cell between a respective UE of one or more UEs served by the cell and the serving node based at least in part of the control information.

This method may for instance be performed and/or controlled by a system, for instance a system comprising at least one apparatus according to the first exemplary aspect, and at least one apparatus according to the second exemplary aspect. Additionally, the system configured to perform and/or control the method according to the third exemplary aspect may comprise at least one UE. For instance, the method may be performed and/or controlled by using at least one processor of at least one apparatus according to the first exemplary aspect, and at least one apparatus according to the second exemplary aspect. The system may for instance be part of a radio network.

According to a further exemplary aspect, a computer program is disclosed, the computer program when executed by a processor causing an apparatus, for instance a server, to perform and/or control the actions of the method according to the first, second and/or third exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first, second and/or third exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the first, second and/or third exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

In the following, exemplary features and exemplary embodiments of all aspects will be described in further detail.

The serving node and/or the SR may be part of a radio network, e.g. a mobile communication network, for example a LTE (Longterm Evolution), 5G NR, or 5GC (5G core) network.

In the radio network, e.g. a 5G NR network, the gNB is a base station that provides NR protocol terminations to the user equipment (UE) and is connected to the 5GC network. The serving node (e.g. a base station such as a gNB) is a logical or a physical node, which may be split into one central unit or centralized unit (CU) and one or more distributed units (DU). The CU hosts the higher layer protocols to the UE and may terminate the control plane and user plane interfaces to the 5GC. The CU controls the one or more DU components or nodes over one or more (established) F1 interfaces, where the DU may host lower protocol layers, e.g. for the NR Uu interface to one or more UEs, to name but one non-limiting example.

One or more of the aspects, realized by example embodiments according to all exemplary aspect may be beneficial:
The SR may comprise both MT (or UE) and (e.g. a subset of) co-located DU functions.
In addition to RRC/MT, SR may set up F1-C as another control link to the serving node CU, which may be carried over RRC e.g. as a container in DLInformationTransfer and ULInformation Transfer-messages.
During the SR integration phase, the F1 is initiated by a F1 SETUP REQUEST message that can indicate the specific node type (e.g. node type: “smart repeater”) which further can imply limited DU capabilities/functions resulting in a specific CU behavior towards the DU and related signalling over F1-C.
F1-C may be used to provide SR with further information such as
   cell activity information, e.g. due to changes with cells served by the serving node, or cells elsewhere in the radio network,
   network deployment, e.g. addition/removal of network nodes
   used power levels,
   serving and neighbor cell configurations including cell states/SSB configurations/etc.

One or more example embodiments according to all exemplary aspects may allow that the smart repeater operation (e.g. of the apparatus according to the first exemplary aspect) can be utilized for coverage extension in radio network scenarios ensuring suitable amplification of received signals and/or avoiding excessive noise or degraded SNR (Signal-to-Noise Ratio) for UEs and/or receiving nodes. With the proposed co-located DU functionality (e.g. of the apparatus according to the first exemplary aspect, also referred to as SR-DU) and F1AP (F1 Application Protocol) control signalling, a SR (e.g. apparatus according to the first exemplary aspect) is able to obtain the needed information to control the repeating of one or more signals of the cell. Thus, example embodiments according to all exemplary aspects may allow to optimize SR operation.

The F1 interface may for instance enable a connection between the apparatus according to the first exemplary aspect (e.g. smart repeater) and the apparatus according to the second exemplary aspect (e.g. CU of the serving node). The F1 interface may be a control path. The F1 interface may carry F1AP messages, e.g. to configure the apparatus according to the first exemplary aspect (e.g. smart repeater).

The F1 interface may utilize a F1AP for providing a signalling service between the DU of the apparatus according to the first exemplary aspect (e.g. the SR), and the apparatus according to the second exemplary aspect (e.g. CU of the serving node). Over the F1 interface, one or more F1AP functions that can be provided to the co-located DU of the apparatus according to the first exemplary aspect (e.g. SR-DU) in a timely manner. In general, such F1AP services may be divided into two groups:
Non UE-associated services: E.g. such services may be related to the F1 interface management between the apparatus (e.g. DU component of the respectively hosted by smart repeater) according to the first exemplary aspect and apparatus according to the second exemplary aspect (e.g. CU of the serving node (e.g. a gNB) utilizing a non UE-associated signalling connection); and
UE-associated services: E.g. such services may be related to one specific UE. F1AP functions that provide these UE-associated services may be associated with a UE-associated signalling connection that is maintained for the UE in question.

The DU co-located on part of the apparatus according to the first exemplary aspect is not serving its own cell—in contrast to a gNB-DU—but rather controlling how the one or more signals of the cell(s) are repeated, e.g. by controlling the amplification and forwarding of repeated one or more signals of the cell(s). The DU of the apparatus according to the first exemplary aspect may not utilize any UE associated signaling. Also, e.g. SR-DU may use the cell configuration information of the serving node (e.g. a gNB, apparatus according to the second exemplary aspect) but not generating cell signals by itself. Due to the having an F1 interface to a CU of a serving node, the apparatus according to the first exemplary aspect is enabled to obtain (e.g. get) information to control an A/F part respectively A/F type repeating of the apparatus according to the first exemplary aspect (e.g. a SR).

According to an exemplary aspect of the first exemplary aspect, the method further comprises:
providing (e.g. sending) a setup request message indicative of a DU capability of the first apparatus (e.g. indicating that not all specified DU capabilities e.g. of a gNB-DU are not needed or supported), wherein with the setup request message, a setup of the F1 interface is initiated; and
obtaining a setup response message indicative of cell information that configure the first apparatus which one or more signals of the cell of the serving node are to be repeated.

According to an exemplary embodiment of the second exemplary aspect, the method further comprises:
obtaining a setup request message indicative of a decentralized unit, DU, capability of the SR, wherein with the setup request message, a setup of the F1 interface is initiated,
providing a setup response message indicative of cell information that configure the SR which one or more signals of the cell of the second apparatus are to be repeated.

The setup request message is provided (e.g. sent) by the apparatus according to the first exemplary aspect (e.g. SR) to the serving node (e.g. apparatus according to the second exemplary aspect), in particular to the CU component or function of the serving node. The setup request message may be a F1 SETUP REQUEST message.

The cell information of the setup response message may for instance represent which cell(s) are to be activated. Further, (re-)configurations e.g. in the form of further configuration information obtained by the apparatus according to the second exemplary aspect, respectively provided by the apparatus according to the second exemplary aspect may be signaled with CONFIGURATION UPDATE/ACK messages, e.g. GNB-CU/GNB-DU CONFIGURATION UPDATE/ACK messages to name but a few non-limiting examples.

According to an exemplary embodiment of the first exemplary aspect, the setup response message is obtained in response to the setup request message (e.g. from the CU of the serving node). According to an exemplary embodiment of the second exemplary aspect, the setup response message is provided in response to the setup message that is obtained (e.g. received) from the apparatus according to the first exemplary aspect (e.g. the SR). The setup response message may be a F1 SETUP REQUEST RESPONSE message. The F1 SETUP REQUEST RESPONSE message may acknowledge the F1 SETUP REQUEST message.

In response to the setup request message, the setup response message is obtained, e.g. by receiving the setup response message, e.g. carried by the RRC signalling by the apparatus according to the first exemplary aspect. The setup response message may acknowledge the setup request message.

The setup request message may for instance be a F1 SETUP REQUEST message. The F1 SETUP REQUEST message may be provided (e.g. sent), e.g. by carrying it over RRC layer (e.g. RRC messages) from the apparatus according to the first exemplary aspect to the apparatus according to the second exemplary aspect. The F1 SETUP REQUEST message may be carried as a transparent container in a RRC message. The setup request message, e.g. F1 SETUP REQUEST message may comprise or represent a node type that requests the setup of the F1 interface. For instance, the node type may comprise or represent the type of a SR, e.g. as a string “SR” or “Smart Repeater”, or a (e.g. binary) identifier in form of one or more bits, to name but a few non-limiting examples. Further, the setup request, e.g. F1 SETUP REQUEST message may comprise or represent information about the DU being hosted (co-located) by the apparatus according to the first exemplary aspect (e.g. a SR node) indicating that not (e.g. all) specified DU capabilities are not needed or supported.

The purpose of the (e.g. F1) setup request message and setup response message (together, both may form a (e.g. F1) setup procedure) may establish a control link via which information (e.g. the control information) needed for controlling the repeating of the apparatus according to the first exemplary aspect can be obtained.

Associated (e.g. configuration) data in particular indicative of the apparatus according to the first exemplary aspect (e.g. smart repeater) having a co-located DU may for instance be stored in both apparatuses, e.g. in a memory (e.g. database) that may be comprised or be connectable to the respective apparatus according to the first and second exemplary aspect.

In this way, the apparatus according to the first exemplary aspect expands the cell of the serving node and can act as a repeater (e.g. using a A/F type repeating enabled by low-cost repeaters) between the CU of the serving node and a respective UE of the one or more UEs served by the apparatus according to the first exemplary aspect.

Further, e.g. over the established F1 interface, e.g. F1-C, control information are obtained (e.g. received). For instance, the control information may provide the apparatus according to the first exemplary aspect with information for performing real time control for SR operation by e.g. adjusting SR pass-band for uplink and/or downlink signals, adjusting amplifier gain, controlling filtering, or the like, wherein these features may optimize the desired signal forwarding of the one or more signals of the cell and minimizing unwanted noise and/or interference amplification thus improving the radio network performance and spectrum utilization.

Via the F1 interface, the apparatus according to the first exemplary aspect may be enabled to obtain (e.g. receive) information such as cell activity information e.g. due to changes with served cells, information indicative of network deployment, information indicative of power levels, information indicative of neighbor cell configurations including cell states/SSB configurations/etc., or a combination thereof, to name but a few non-limiting examples. The setup response message, e.g. F1 SETUP RESPONSE message provided by the apparatus according to the second exemplary aspect may include cell configuration of the serving node e.g. providing the basic information about the cell configurations that shall be repeated by the apparatus according to the first exemplary aspect. The control plane signaling of the F1 interface (F1AP, F1 application protocol) may be available for further configuration and updates that the F1AP is supporting, e.g. with GNB CU CONFIGURATION UPDATE, GNB DU CONFIGURATION UPDATE, GNB CU CONFIGURATION UPDATE ACKNOWLEDGEMENT, GNB DU CONFIGURATION UPDATE ACKNOWLEDGEMENT, etc. The established F1 interface allows also transfer of non-specified control information for any proprietary enhancements for the SR operation.

The control information may for instance be provided (e.g. by the apparatus according to the second exemplary aspect) in intervals so that the apparatus according to the first exemplary aspect can obtain (e.g. receive) them in pre-determined time intervals and, thus, have up-to-date control information. The control information may be obtained by the apparatus according to the first exemplary aspect in real-time. The control information may overwrite existing control information. This may allow to update how the apparatus according to the first exemplary aspect performs repeating respectively forwarding of the one or more signals (e.g. data transmissions) in its role as a smart repeater.

The apparatus according to the first exemplary aspect is enabled to forward data transmission(s) between a respective UE of the one or more UEs and the serving node, wherein e.g. a suitable amplification can be ensured by determining the amplification based, at least in part, on the obtained control information prior to the forwarding of the data transmission(s). This may allow to avoid excessive noise, interference and/or degraded SNR for the respective UE and/or one or more receiving nodes, e.g. such as the apparatus according to the second exemplary aspect (e.g. CU of a serving node).

By the co-located DU (of the apparatus according to the first exemplary aspect) and F1AP (F1 application protocol) control signalling (between the serving node CU and the SR), additional information can be provided respectively obtained by the apparatus according to the first exemplary aspect for optimized SR operation, since controlling of A/F type repeating, e.g. minimizing interference(s) and noise, allowing to control amplification (e.g. only) for a desired signal or band, and enabling gain control to be adjusted is achieved.

According to an exemplary embodiment of all exemplary aspects, the setup request message and/or the setup response message use radio resource control, RRC, signaling. RRC may be used to (e.g. initially) configure the apparatus according to the first exemplary aspect. RRC may be used as a transport layer to establish the F1 interface (e.g. initially) by transferring, transparently to the RRC layer, the F1AP signaling in a container of a RRC message. Using the RRC as the transport layer for F1 signaling enables extensions to F1 control signaling, also proprietary signaling, without changes required to the RRC signaling. Therefore, the specification changes would be needed only for the RAN interface specifications, and not necessarily for the air interface (Uu) specifications. Then, via the F1 interface, appropriate control information may be obtainable (e.g. receivable) by the apparatus according to the first exemplary aspect (from the apparatus according to the second exemplary aspect) allowing to follow (e.g. in real-time) possible changes in the radio network and e.g. allowing to adjust power levels of Tx signals (e.g. data transmissions) to be forwarded/repeated by the apparatus according to the first exemplary aspect, to name but a few non-limiting examples. A respective RRC message may for instance comprise or be a DLInformationTransfer and/or ULInformationTransfer message. The setup request message (e.g. F1 SETUP REQUEST message) may for instance be transmitted as a container in an ULInformationTransfer. The setup response message may be transmitted as a container in a DLInformation Transfer message. Such RRC messages can be used to transfer dedicated Information from/to the serving node to/from the SR, e.g. via RRC signalling, e.g. as a part of RRC_CONNECTED procedure.

According to an exemplary embodiment of the first exemplary aspect, the apparatus is configured to host a mobile terminated, MT, component.

By hosting the MT component, the apparatus according to the first exemplary aspect may further connect to its serving cell inheriting properties of a regular UE. The MT component may establish a control link to the (e.g. CU of the) serving node, wherein control information may for instance be transmitted via a respective radio resource control message for the MT component of the apparatus according to the first exemplary aspect, while control information for repeating/forwarding of the one or more signals (e.g. data transmissions) of the cell may be transmitted via the F1 interface. This may allow that the apparatus (e.g. smart repeater) according to the first exemplary aspect hosts both MT and co-located DU functions and sets up F1-C (F1-control plane interface) connection to a serving CU (e.g. gNB-CU as represented by the apparatus according to the second exemplary aspect).

According to an exemplary embodiment of all exemplary aspects, the F1 interface is a F1-control plane interface connection, F1-C, between the CU of the serving node (e.g. apparatus according to the second exemplary aspect) and the SR (e.g. apparatus according to the first exemplary aspect). The F1-control plane interface is used to obtain control information. Via the F1-control plane interface, an operation of the apparatus can be managed by serving node CU.

The F1 interface may connect the CU of the serving node (e.g. a gNB CU) to the DU of the apparatus of the first exemplary aspect. As known from the standard, in general the F1 interface connects a gNB CU to one of its gNB DUs. As is disclosed herein, the F1 interface connects e.g. the gNB CU to one of its DUs, in particular to a co-located DU of a SR (e.g. apparatus according to the first exemplary aspect). The F1 interface is applicable to the CU-DU Split gNB architecture, e.g. as utilized by 5G NR or in particular by the 5GC of 5G NR radio networks. The control plane of the F1 interface (F1-C) allows signaling between the CU of the serving node (e.g. apparatus according to the second exemplary aspect) and DU of the apparatus according to the first exemplary aspect. For the sake of completeness, the user plane of the F1 (F1-U) of the F1 interface allows the transfer of e.g. application data.

According to an exemplary embodiment of all exemplary aspects, the control information obtained via the F1 interface (e.g. by the apparatus according to the first exemplary aspect from the apparatus according to the second exemplary aspect) comprises one or more of the following information, not limiting to the examples:
cell activity information;
network deployment information;
power level information;
SR pass-band (re-)configuration information;
adjustment information;
gain control information; and
filter information.

Cell activity information may for instance represent cell (re-)activation, or cell de-activation information. Cell activity information may refer to respectively represent cells of the serving node(s) or cells of other (neighbor) nodes in the radio network.

Network deployment information may for instance represent information about node addition, node removal, changes in site (e.g. antenna) configuration, or a combination thereof.

Power level information may for instance represent information about cell downlink (DL) transmit (TX) power(s) for cell(s) of the serving node and/or cell (s=of neighboring node(s).

SR pass-band (re-)configuration information may for instance represent total band received and/or amplified by the SR (e.g. apparatus according to the first exemplary aspect), sub-bands of non-contiguous frequency allocations to served cells, or a combination thereof, to name but a few non-limiting examples.

Adjustment information may for instance be indicative of an adjustment of SR UL/DL TX power.

Gain control information may for instance be indicative of instructions for SR gain or gain control.

Filter information may for instance be indicative of re-configuration of filter parameters of the SR signal path (e.g. one or more configuration parameters for filter(s) of the SR signal path).

Optionally, the control information may further comprise one or more of the following information:
dynamic TDD confirmation information; and
UE specific beamforming information.

One or more of aforementioned information may allow to perform controlling of the repeating performed by the apparatus according to the first exemplary aspect. One or more of aforementioned information may allow to perform adaptive beamforming for enhancing cell coverage, optionally for a specific UE of the one or more UEs, and/or to adapt the beamforming to a specific UE of one or more UEs served by the apparatus according to the first exemplary aspect. In general, by enabling beamforming for repeating of one or more signals (e.g. data transmissions) to a specific UE, the beamforming may allow to enhance a cell footprint of the cell provided by the serving node (e.g. gNB) that is enhanced by the apparatus according to the first exemplary aspect in its role as a smart repeater.

Coverage provided by one or more cells of the radio network is an aspect of cellular network deployments, which may be represented by network deployment information. Radio network (e.g. 5G NR) operation may rely on a certain spectrum and transmission band(s). Such transmission band(s) may be TDD bands and in particular at higher frequencies (approx. 4 GHz for FR1 operating band and above 24 GHz for FR2 operating band), multi-antenna beamforming may be enabled, e.g. by massive MIMO (Multiple-Input Multiple Output) for FR1 operating band, and/or analog beamforming for FR2 operating band. To allow the apparatus according to the first exemplary aspect to forward data transmissions e.g. utilizing such beamforming to a specific UE, e.g. the control information may be used.

Further, for allowing the apparatus according to the first exemplary aspect to forward data transmission(s) e.g. utilizing semi-static or dynamic TDD, respective semi-static or dynamic TDD confirmation information that can be comprised by the control information.

These are a few non-limiting examples of the apparatus according to the first exemplary aspect, wherein the apparatus performs repeating/forwarding of the one or more signals based at least in part on the control information obtained via the F1 interface.

According to an exemplary embodiment of the first exemplary aspect, the method further comprises:
obtaining repeater configuration information indicative of configuring the first apparatus for the co-located DU function.

The repeater configuration information may be obtained via RRC signalling. Additionally, or alternatively, the repeater configuration information may be obtained e.g. from a memory of the first apparatus, in which the repeater configuration information for the co-located (e.g. SR-) DU function may be pre-configured, e.g. during manufacturing or prior to the installation of the first apparatus to name a few non-limiting examples.

According to an exemplary embodiment of the first exemplary aspect, the repeating is an amplify-and-forward, A/F, type repeating. According to an exemplary embodiment of the first exemplary aspect, based on the control information, the amplify-and-forward, A/F, type repeating is controlled.

According to an exemplary embodiment of the first exemplary aspect, the A/F type repeating is controlled by an adjusting of a pass-band for one or more uplink and/or downlink signals of the one or more signals, an adjusting of an amplifier gain, a controlling of a filtering of the one or more signals, or a combination thereof. As disclosed above, cell activity information, network deployment information, power level information, neighbor cell information, or a combination thereof may enable the apparatus according to the first exemplary aspect to handle a signal repeating/forwarding of the one or more signals for example by adjusting SR pass-band for uplink and/or downlink signals, adjusting amplifier gain, adjusting filter parameters, or the like. This may be done by adjusting such features of an antenna panel of the apparatus according to the first exemplary aspect. In this way, it may be allowed to improve the radio network performance and spectrum utilization. The controlling of the repeating may be based, at least in part, on the obtained control information. The control information may be obtained in a timely manner, e.g. so that the apparatus according to the first exemplary aspect can control the A/F type repeating in real-time.

According to an exemplary embodiment of the first exemplary aspect, the apparatus is a smart repeater, and/or wherein the serving node is a base station (e.g. a gNB) of the radio network.

Since the apparatus according to the first exemplary aspect provides respectively may provide the setup request message, the apparatus according to the second exemplary aspect may obtain respectively may have obtained the setup request message, e.g. by receiving the setup request message, e.g. via RRC signalling. In response to obtaining the setup request message, the apparatus according to the second exemplary aspect may provide a setup response message. Further, control information may be provided to the apparatus according to the first exemplary aspect via the (then established) F1 interface for enabling the apparatus according to the first exemplary aspect to e.g. control the repeating based on the control information. The coverage of the cell may be expanded by the apparatus according to the first exemplary aspect.

According to an exemplary embodiment of the second exemplary aspect, the method further comprises:
providing repeater configuration information indicative of configuring the SR for the co-located DU function.

Additionally or alternatively, the apparatus according to the first exemplary aspect may connect to a network management system, e.g. an operations, administration and maintenance center (OAM), e.g. to obtain repeater configuration information for the co-located SR-DU function. Alternatively, the SR-DU configuration may also be pre-configured prior to the installation. The repeater configuration information may not include any cell configuration information, since an A/F-type repeating, as done based on the control information by the apparatus according to the first exemplary aspect does not serve cell(s) of its own but repeats those of the serving node (e.g. a gNB; apparatus according to the second exemplary aspect.

According to an exemplary embodiment of the second exemplary aspect, the apparatus is a base station (e.g. gNB, ng-gNB, en-gNB) of the radio network. The gNB, as used herein, is understood as a Next generation nodeB. The ng-gNB is a next generation-eNB, e.g. an enhanced eNB (evolved NodeB) of a 4G radio network that connects to the 5GC radio network. The en-gNB, as used, herein, is understood to be a base station of a 4G radio network that is connected to a 5G (e.g. NR) network, wherein a respective 5G (e.g. NR) gNB connects to the 4G Core network. More specifically, the 4G eNB then acts as a master node (MeNB) that is in control of a radio connection with a respective UE, wherein the en-gNB is used as a Secondary Node (SgNB).

The features and example embodiments described above may equally pertain to the different aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 a schematic block diagram of a system according to an exemplary aspect;

FIG. 2 a flowchart showing an example embodiment of a method according to the first exemplary aspect;

FIG. 3 a flowchart showing an example embodiment of a method according to the second exemplary aspect;

FIG. 4 example transmissions and example actions performed by a first apparatus, second apparatus and a UE;

FIG. 5 a flowchart showing examples of controlling a repeating, as utilized by example embodiments of all exemplary aspects;

FIG. 6 a schematic block diagram of an apparatus configured to perform the method according to the first exemplary aspect; and

FIG. 7 a schematic block diagram of an apparatus configured to perform the method according to the first exemplary aspect.

### DETAILED DESCRIPTION OF SOME EXEMPLARY EMBODIMENTS

The following description serves to deepen the understanding and shall be understood to complement and be read together with the description as provided in the above summary section of this specification.

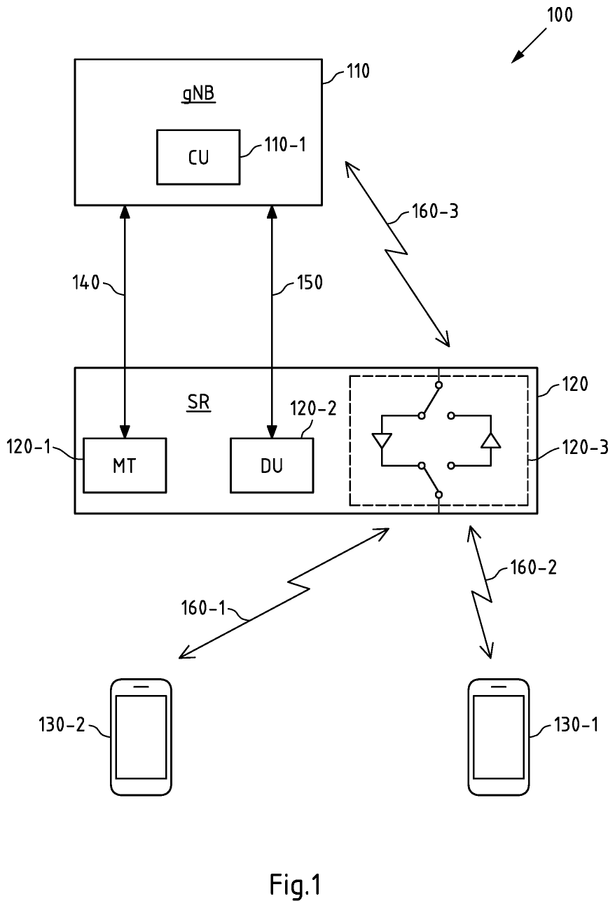

FIG. 1 is a shows a schematic high-level block diagram of a system 100 according to an exemplary aspect. System 100 comprises a gNB 110 (e.g. apparatus according to the second exemplary aspect) and a SR 120 (e.g. apparatus according to the first exemplary aspect). System 100 may further comprise one or more UEs, exemplary two UEs 130-1, 130-2 are shown, which are served by the SR 120 to extend a coverage of a cell.

The gNB 110 comprises a CU 110-1, and optionally one or more gNB-DUs not shown in FIG. 1, which may be connected to the CU 110-1 via a respective (e.g. dedicated) F1 interface.

The SR 120 comprises a MT component 120-1, a co-located DU component 120-2, and an A/F part enabled to perform A/F type repeating of one or more signals respectively data transmissions of the cell of the gNB 110.

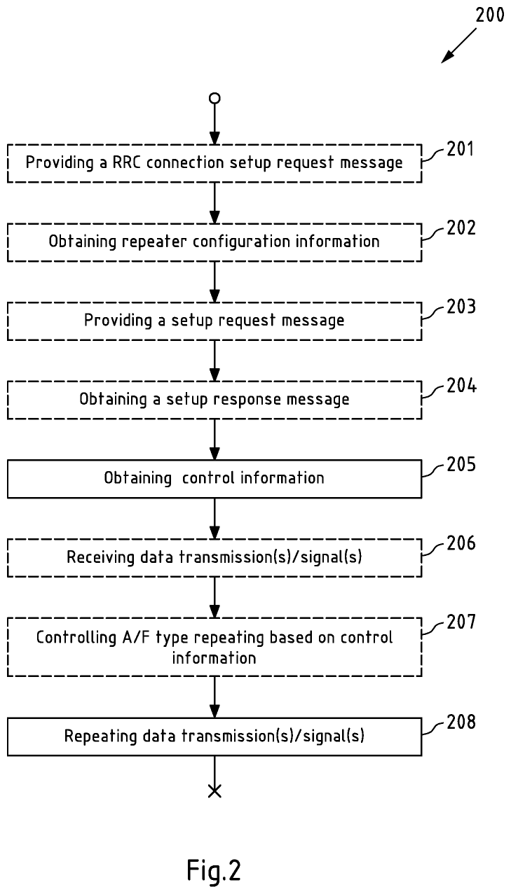

Between the gNB 110 and the SR 120, there is established a control link 140, via which e.g. a connection setup request message (see e.g. step 203 of FIG. 2) and a setup complete message (see e.g. step 204 of FIG. 2) may be transmitted. This connection setup procedure may establish a RRC connection between the CU and SR-MT. Via the control link 140, RRC messages may be exchanged. Via the control link 140, another control link 150 via a F1 interface may be established between the CU and SR-DU. The arrows 140 and 150 represent the logical connection for the control links 140 and 150 between the MT component 120-1 and the co-located DU component 120-2 of the SR 120 and the gNB 110. The F1 interface is used by the SR 120 to obtain control information from the gNB 110 respectively the gNB-CU 110-1. This allows that the SR 120 can forward/repeat data transmissions e.g. between the gNB 110 and a respective UE 130-1, 130-2, wherein the signal reception and forwarding of the data transmission(s) is controlled based on the control information, e.g. enabling adjusting SR pass-band for uplink and/or downlink signals, adjusting amplifier gain, controlling filtering, or the like, which allows minimizing of unwanted noise and/or interference amplification although the forwarding/repeating is done by the A/F part 120-3. This allows the SR 120 to not rely on sole A/F repeating, but to improve the forwarding of data transmission(s) since e.g. interferences and noise in the communication link between a respective UE 130-1, 130-2 and e.g. the gNB 110 can be reduced, to name but one non-limiting example.

Data transmission(s) respective signal(s) of a cell of the gNB 110 can be repeated to/from a respective UE 130-1, 130-2, which is illustrated in FIG. 1 by the double 160-1 and 160-2 between the A/F part 120-3 of the SR 120 and the respective UEs 130-1, 130-2, and the double arrow 160-3 between the A/F part 120-3 of the SR 120 and the gNB 110. The double arrows 160-1, 160-2 and 160-3 represent actual radio signal(s) transmitted/received over the radio interface of the gNB 110, the SR 120 and the UEs 130-1 and 130-2.

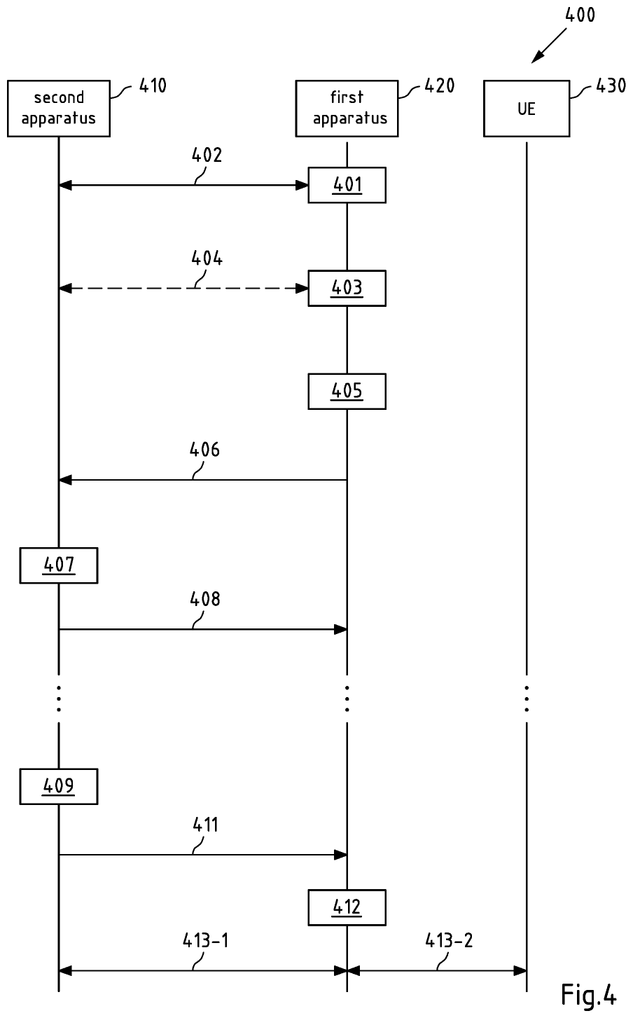

FIG. 2 is a flowchart 200 showing an example embodiment of a method according to the first exemplary aspect. This flowchart 200 may for instance be performed by a SR, e.g. apparatus (e.g. SR) 120 of FIG. 1, and/or 420 of FIG. 4.

In a first step 201, a RRC connection setup request message is provided, e.g. by the SR MT (see MT 120-1 of FIG. 1). The SR MT may establish a radio connection to the serving node (e.g. gNB 110 of FIG. 1) by providing (e.g. sending) the RRC connection setup request message to the gNB respectively gNB-CU (e.g. the apparatus (e.g. a gNB) 110-1 of FIG. 1). The following radio connection setup procedure can utilize a standard setup procedure, e.g. as specified for UEs according to a communication standard of the radio network, e.g. 5G NR communication standard. During the setup procedure, the SR (e.g. SR 120 of FIG. 1) may indicate the type of the node (e.g. being SR), or in addition or in the alternative, the node type may be obtained (e.g. become available) from a/the subscription information in the core network (CN).

In a second step 202, repeater configuration information are obtained. For instance after the first step 201, the SR may connect to an operations, administration and maintenance center (OAM) of the radio network to obtain (e.g. retrieve) repeater configuration information for the co-located SR-DU function of the SR. Alternatively, the SR-DU configuration may also be pre-configured prior to the installation. The SR-DU configuration may not include any cell configuration as an A/F-type of SR does not serve cell(s) of its own but repeats those of the gNB.

In a third step 203, the setup request message may be provided, e.g. to the gNB. Once the RRC connection is available (see steps 201 and 202), RRC signaling can be used to carry F1 related messages in a transparent manner. With the connection, the SR-DU can initiate F1 setup procedure by providing (e.g. sending) the setup request message, e.g. F1 SETUP REQUEST message to the gNB-CU. The F1 SETUP REQUEST message may include information about the DU being hosted by a SR node indicating that not all specified DU capabilities are not needed or supported. In response, in a fourth step 204, the setup response message, e.g. a F1 SETUP RESPONSE message is obtained, e.g. sent back by the gNB-CU. The setup response message may include cell configuration of the serving gNB providing the basic information about the cell configurations that shall be repeated by the SR (see step 208). After this step 204, the control plane signaling of the F1 interface (e.g. F1AP, F1 application protocol, or any proprietary control signaling) is available for further configuration and updates that the F1AP may be supporting.

Thus, in a fifth step 205, control information are obtained via the F1 interface. The control information allows the SR to perform enhanced (e.g. smart) repeater functions providing information that is not available in the other control links or are not available in a timely manner. Such information supported by the F1AP may be, for example, cell (re-)activation or de-activation of the serving or neighboring node, new cell/node deployments and their cell configurations, (re-)configuration of SR pass-band, transmit (TX) powers of the serving and neighboring cells, filter parameters, SR gain or gain control parameters, or the like. This enables the SR to perform advanced control of the signal reception and (data) transmission. The SR can perform real time control for SR operation by e.g. adjusting SR pass-band for uplink and/or downlink signals, adjusting amplifier gain, controlling filtering, or the like, wherein these features optimize the desired signal forwarding and minimizing unwanted noise and/or interference amplification thus improving the radio network performance and spectrum utilization.

In an optional sixth step 206, data transmission(s) respectively one or more signals are received by the SR to be repeated/forwarded. The data transmission(s) may for instance be received from a respective UE, and/or from a plurality (e.g. at least two) of UEs, and/or from the gNB, to name but a few non-limiting examples.

In an optional seventh step 207, controlling of A/F type repeating based on the control information is done. For instance, dynamic adjustment of SR pass-band, filtering, SR gain, TX power, or the like, is performed for or during the forwarding of the one or more (e.g. data) signal(s). Step 207 is based, at least in part, on the control information of step 205. It will be understood that such control information as obtained in step 205 may be obtained by the SR a plurality of times (e.g. at least twice) so that the SR handles the forwarding of data transmission(s) e.g. according to the most recently obtained control information, to name but one non-limiting example.

In an eighth step 208, the actual repeating of the data signal(s) is done. Steps 207 and 208 may be related to one another, and in particular be performed together in a single step of the repeating.

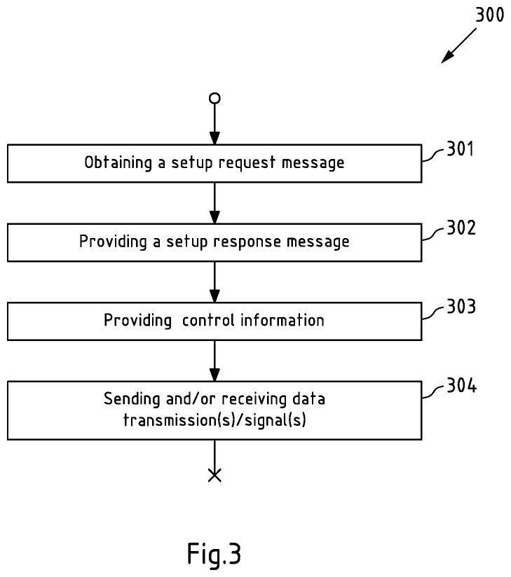

FIG. 3 is a flowchart 300 showing an example embodiment of a method according to the second exemplary aspect. This flowchart 300 may for instance be performed by a gNB and/or serving node and/or CU of the gNB and/or serving node (e.g. the apparatus (e.g. a gNB) 110 of FIG. 1, and/or 410 of FIG. 4).

In a first step 301, a setup request message is obtained, e.g. by receiving it via RRC signaling from a SR (e.g. apparatus according to the first exemplary aspect). The setup request message may be based on RRC signaling and can be used to carry F1 related messages in a transparent manner.

In a second step 302, a setup response message is provided, e.g. by sending it e.g. via RRC signalling to the SR from which the setup request message of step 301 is obtained. With the steps 301 and 302, the SR-DU (see SR-DU 120-2 of FIG. 1) can initiate a F1 setup procedure as disclosed above with regard to FIG. 2 with the apparatus performing and/or controlling the flowchart 300.

In a third step 303, control information are provided to the SR respectively the DU component of the SR, e.g. from the gNB-CU. The control information are provided via a F1 interface established between the gNB respectively gNB-CU and the co-located DU component hosted by the SR.

In a fourth step 304, data transmission(s) signals are sent/received to/from the SR, e.g, wherein the data transmission(s) are e.g. received from the SR utilizing the control information of step 303 to control the repeating by e.g. adjusting SR pass-band for uplink and/or downlink signals, adjusting amplifier gain, controlling filtering, or the like of the SR.

The flowchart 200 of FIG. 2 and the flowchart 300 of FIG. 3 together show an example embodiment of the method according to the third exemplary aspect, e.g. performed by a system 100 of FIG. 1, and/or system 400 of FIG. 4.

FIG. 4 shows example procedure to establish another control link and example actions performed by a first apparatus 420, second apparatus 410 and a UE 430.

In an action 401, the first apparatus (e.g. a SR) 420 generates a RRC connection setup request message. This message is provided to the second apparatus 410. This initiates a radio connection setup procedure, as shown by the double arrow 402. The radio connection setup procedure may utilize a standard setup procedure specified for UEs according to the communication standard of the radio network, e.g. 5G NR.

In an action 403, the first apparatus 420 requests repeater configuration information. In an example embodiment, the repeater configuration information may be obtained via the second apparatus 410, e.g. the second apparatus may forward the repeater configuration information to the first apparatus 420. The obtaining of the repeater configuration information via the second apparatus 410 is illustrated by the dashed double arrow 404 and is optional. For instance, in the alternative, the repeater configuration information may be obtained by the first apparatus from an operations, administration and maintenance center (OAM), or it is retrieved from a configuration file stored during installation of the first apparatus 420.

In an action 405, the first apparatus 420 generates a setup request message. The setup request message comprises e.g. an information element/field with a content indicative of a node type, e.g. node type indicating that the first apparatus 420 is a SR. Further, the setup request message may comprise in the information element/field or in another information element/field a content indicative of a subset of one or more DU functions to be supported by the first apparatus 420 when it has a co-located DU for the second apparatus 410.

The setup request message is transmitted in transmission 406 from the first apparatus 420 to the second apparatus 410 (e.g. gNB respective gNB-CU). The setup request message may be transmitted transparently via RRC signalling, for instance as a container in ULInformationTransfer-messages. The setup request message may be a F1 SETUP REQUEST message.

In an action 407, the second apparatus 410 retrieves/generates e.g. cell configuration of the second apparatus 410 and then provides the basic information about the cell configurations that shall be repeated by the first apparatus 420 in the transmission 408, as a setup response message, e.g. F1 SETUP RESPONSE message. This message is transmitted in transmission 408 from the second apparatus 410 to the first apparatus 420, e.g. transparently via RRC signalling, for instance using e.g. DLInformation Transfer message.

In an action 409, the second apparatus 410 generates a control information comprising an information element/field with a content indicative of one or more parameters, such as cell activity information; network deployment information; power level information; neighbor cell information; TDD configuration information; or a combination thereof. In transmission 411, the control information is transmitted via the F1 interface from the second apparatus 410 to the first apparatus 420. This enables the first apparatus 420 to optimize signal forwarding for example by adjusting SR pass-band for uplink and/or downlink signals, adjusting amplifier gain, adjusting filter parameters, or the like, all features optimizing the desired signal forwarding and minimizing unwanted noise and/or interference amplification thus improving the radio network performance and spectrum utilization, as exemplary shown by action 412, in which the first apparatus 420 may e.g. adjust amplification and/or filtering parameters based on the control information for the repeating, indicated by the double arrows 413-1 and 413-2 pointing between the first apparatus 420, the second apparatus 410 and the UE 430.

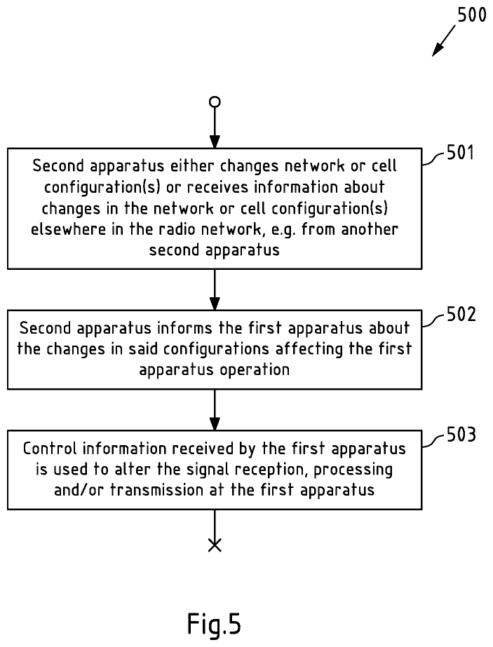

FIG. 5 shows a flowchart showing examples of controlling a repeating, as utilized by example embodiments of all exemplary aspects.

In a step 501, the second apparatus (e.g. gNB-CU, such as gNB-CU 110-1 of FIG. 1) may either modify the cells (cell (re-)activation, deactivation, power levels, or other relevant parameters) of one or more DUs under its own control, is connected to a new DU serving new cells, or gets similar information from another CU, or a combination thereof.

In step 502, the second apparatus may determine whether the changes (e.g. of step 501) are affecting the SR operation and whether there is need for modifications for the SR (e.g. SR 120 of FIG. 1) configuration. The configuration may refer to width of pass-band, modified filtering, modified SR gain on UL and/or DL, modified TX power, stopping the SR operation, or the like. The second apparatus informs the first apparatus (e.g. SR-DU such as DU 120-2 of FIG. 1) about the new configuration by signalling over F1 interface.

In step 503, having received the updated SR configuration information, the first apparatus may initiate modification for the SR operation according the indicated new configuration information, e.g. as represented by the control information. For example, A/F transceiver parameters (pass-band, gain, filter parameters, TX power, or the like) of the A/F part (e.g. A/F part 120-3 of FIG. 1) may be adjusted according to the new values, to name but one non-limiting example. The first apparatus may then perform repeating of the one or more signals of the cell (see also step 207 and 208 of FIG. 2).

Steps 501, 502 and/or 503 may for instance be performed by the apparatus performing and/or controlling the flowchart 200 of FIG. 2, for performing the repeating based at least in part on the control information.

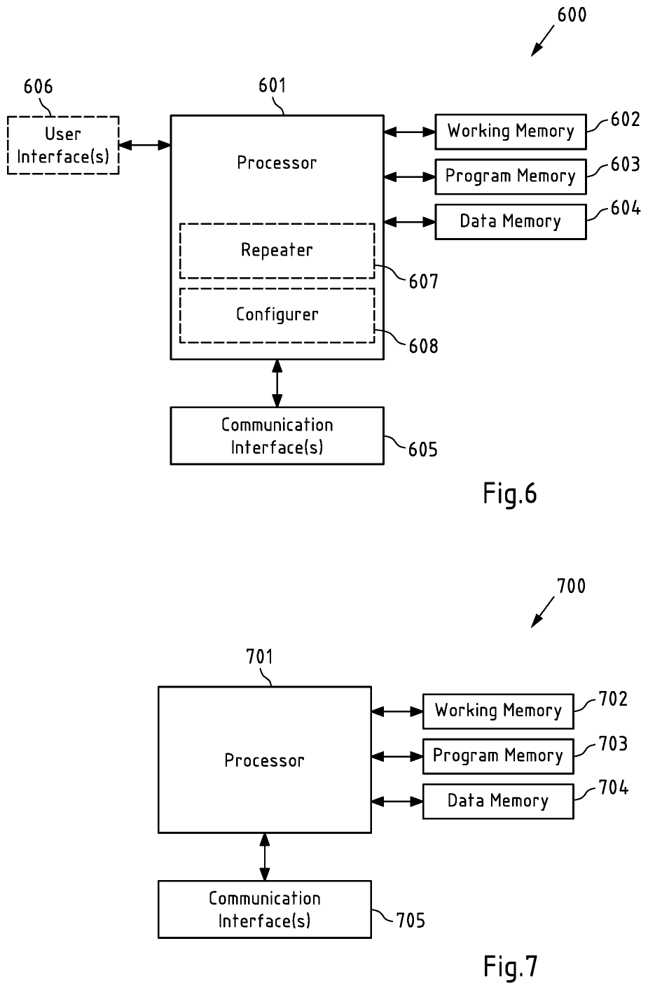

FIG. 6 is a schematic block diagram of an apparatus 600 according to the first exemplary aspect, which may for instance represent the apparatus (e.g. SR) 120 of FIG. 1, and/or 420 of FIG. 4.

Apparatus 600 comprises a processor 601, working memory 602, program memory 603, data memory 604, communication interface(s) 605, and an optional user interface 606.

Apparatus 600 may for instance be configured to perform and/or control or comprise respective means (at least one of 601 to 606) for performing and/or controlling the method according to the first exemplary aspect, and/or at least a part of the method according to the third exemplary aspect. Apparatus 600 may as well constitute an apparatus comprising at least one processor (601) and at least one memory (602) including computer program code, the at least one memory and the computer program code configured to, with the at least one processor, cause an apparatus, e.g. apparatus 600 at least to perform and/or control the method according to the first exemplary aspect.

Processor 601 may for instance comprise a repeater 607 as a functional and/or structural unit. Repeater 607 may for instance be configured to forward data transmission(s) (see step 207 of FIG. 2).

Processor 601 may for instance comprise a configurer 608 as a functional and/or structural unit. Configurer 608 may for instance be configured to generate a setup request message for setting up to host a DU (see step 201 of FIG. 2).

Processor 601 may for instance further control the memories 602 to 604, the communication interface(s) 605, the optional user interface 606 and the optional sensor(s) 607.

Processor 601 may for instance execute computer program code stored in program memory 603, which may for instance represent a computer readable storage medium comprising program code that, when executed by processor 601, causes the processor 601 to perform the method according to the first exemplary aspect.

Processor 601 (and also any other processor mentioned in this specification) may be a processor of any suitable type. Processor 601 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 601 may for instance be an application processor that runs an operating system.

Program memory 603 may also be included into processor 601. This memory may for instance be fixedly connected to processor 601, or be at least partially removable from processor 601, for instance in the form of a memory card or stick. Program memory 601 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 603 may also comprise an operating system for processor 601. Program memory 603 may also comprise a firmware for apparatus 600.

Apparatus 600 comprises a working memory 602, for instance in the form of a volatile memory. It may for instance be a Random Access Memory (RAM) or Dynamic RAM (DRAM), to give but a few non-limiting examples. It may for instance be used by processor 601 when executing an operating system and/or computer program.

Data memory 604 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 604 may for instance store one or more setup request messages, one or more setup response message, one or more control messages, one or more control information, one or more data transmissions, or a combination thereof.

Communication interface(s) 605 enable apparatus 600 to communicate with other entities, e.g. with a serving node, e.g. gNB 110 or CU 110-1 of FIG. 1, or gNB 410 of FIG. 4, or gNB 510 of FIG. 5. The communication interface(s) 605 may for instance comprise a wireless interface, e.g. a cellular radio communication interface and/or a WLAN interface) and/or wire-bound interface, e.g. an IP-based interface, for instance to communicate with entities via the Internet.

User interface 606 is optional and may comprise a display for displaying information to a user and/or an input device (e.g. a keyboard, keypad, touchpad, mouse, etc.) for receiving information from a user.

Some or all of the components of the apparatus 600 may for instance be connected via a bus. Some or all of the components of the apparatus 600 may for instance be combined into one or more modules.

FIG. 7 is a schematic block diagram of an apparatus 700 according to the second exemplary aspect, which may for instance represent the apparatus (e.g. a gNB) 110 of FIG. 1, and/or 410 of FIG. 4.

Apparatus 700 comprises a processor 701, working memory 702, program memory 703, data memory 704, communication interface(s) 705.

Apparatus 700 may for instance be configured to perform and/or control or comprise respective means (at least one of 701 to 705) for performing and/or controlling the method according to the second exemplary aspect, and/or at least a part of the method according to the third exemplary aspect. Apparatus 700 may as well constitute an apparatus comprising at least one processor (701) and at least one memory (702) including computer program code, the at least one memory and the computer program code configured to, with the at least one processor, cause an apparatus, e.g. apparatus 700 at least to perform and/or control the method according to the first exemplary aspect.

Processor 701 may for instance further control the memories 702 to 704, the communication interface(s) 705.

Processor 701 may for instance execute computer program code stored in program memory 703, which may for instance represent a computer readable storage medium comprising program code that, when executed by processor 701, causes the processor 701 to perform the method according to the second exemplary aspect.

Processor 701 (and also any other processor mentioned in this specification) may be a processor of any suitable type. Processor 701 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 701 may for instance be an application processor that runs an operating system.

Program memory 703 may also be included into processor 701. This memory may for instance be fixedly connected to processor 701, or be at least partially removable from processor 701, for instance in the form of a memory card or stick. Program memory 701 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 703 may also comprise an operating system for processor 701. Program memory 703 may also comprise a firmware for apparatus 700.

Apparatus 700 comprises a working memory 702, for instance in the form of a volatile memory. It may for instance be a Random Access Memory (RAM) or Dynamic RAM (DRAM), to give but a few non-limiting examples. It may for instance be used by processor 701 when executing an operating system and/or computer program.

Data memory 704 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 704 may for instance store one or more setup request messages, one or more setup response message, one or more control messages, one or more control information, one or more data transmissions, or a combination thereof.

Communication interface(s) 705 enable apparatus 700 to communicate with other entities, e.g. with a SR 120 respectively DU of the SR 120 of FIG. 1, or SR 420 of FIG. 4, or SR 520 of FIG. 5. The communication interface(s) 705 may for instance comprise a wireless interface, e.g. a cellular radio communication interface and/or a WLAN interface) and/or wire-bound interface, e.g. an IP-based interface, for instance to communicate with entities via the Internet.

Some or all of the components of the apparatus 700 may for instance be connected via a bus. Some or all of the components of the apparatus 700 may for instance be combined into one or more modules.

The following embodiments shall also be considered to be disclosed:

### Embodiment 1

A method (e.g. performed and/or controlled by at least one first apparatus), the method comprising:
obtaining control information indicative of one or more control parameters for controlling a repeating of one or more signals of a cell of a serving node that is served by a first apparatus, wherein the control information is obtained from the serving node via a F1 interface established between a centralized unit, CU, of the serving node and a co-located distributed unit, DU, function on part of the first apparatus of a radio network; and
repeating the one or more signals of the cell between a respective UE of one or more UEs served by the cell and the serving node based at least in part of the control information.

### Embodiment 2

The method of embodiment 1, further comprising:
providing a setup request message indicative of a DU capability of the first apparatus, wherein with the setup request message, a setup of the F1 interface is initiated; and
obtaining a setup response message indicative of cell information that configure the first apparatus which one or more signals of the cell of the serving node are to be repeated.

### Embodiment 3

The method according to embodiment 2, wherein the setup request message and/or the setup response message use radio resource control, RRC, signaling.

### Embodiment 4

The method according to any of the preceding embodiments, wherein the F1 interface is a F1-control plane interface connection to the CU of the serving node.

### Embodiment 5

The method according to any of the preceding embodiments, wherein the control information comprises one or more of the following information:
cell activity information;
network deployment information;
power level information;
SR pass-band configuration information and/or SR pass-band re-configuration information;
adjustment information;
gain control information; and
filter information.

### Embodiment 6

The method according to any of the preceding embodiments, further comprising:
obtaining repeater configuration information indicative of configuring the first apparatus for the co-located DU function.

### Embodiment 7

The method according to any of the preceding embodiments, wherein based on the control information, an amplify-and-forward, A/F, type repeating enabled by the first apparatus is controlled.

### Embodiment 8

The method according to embodiment 7, wherein the A/F type repeating is controlled by an adjusting of a pass-band for one or more uplink and/or downlink signals of the one or more signals, an adjusting of an amplifier gain, a controlling of a filtering of the one or more signals, or a combination thereof.

### Embodiment 9

The method according to any of the preceding embodiments, wherein the first apparatus is a smart repeater, and/or wherein the serving node is a base station or a gNB of the radio network.

### Embodiment 10

An apparatus configured to perform and/or control or comprising respective means for performing and/or controlling the method of any of the embodiments 1 to 9.

### Embodiment 11

An apparatus comprising at least one processor and at least one memory including computer program code, the at least one memory and the computer program code configured to, with the at least one processor, cause an apparatus at least to perform and/or control the method of any of the embodiments 1 to 9.

### Embodiment 12

A method (e.g. performed and/or controlled by at least one second apparatus), the method comprising:
providing control information indicative of one or more control parameters for controlling a repeating of one or more signals of a cell of the second apparatus that is served by a smart repeater, SR, wherein the control information is provided via a F1 interface established between a centralized unit, CU, of a second apparatus and a co-located distributed unit, DU, function on part of the SR of a radio network; and sending and/or receiving one or more signals of the cell to and/or from the SR.

### Embodiment 13

The method according to embodiment 12, further comprising:
obtaining a setup request message indicative of a DU capability of the SR, wherein with the setup request message, a setup of the F1 interface is initiated; and
providing a setup response message indicative of cell information that configure the SR which one or more signals of the cell of the second apparatus are to be repeated.

### Embodiment 14

The method according to any of the embodiments 12-13, wherein the setup request message and/or the setup response message use radio resource control, RRC, signaling.

### Embodiment 15

The method according to any of the embodiments 12-14, wherein the F1 interface is a F1-control plane interface connection to the SR.

### Embodiment 16

The method according to any of the embodiments 12-15, wherein the control information comprises one or more of the following information:
cell activity information;
network deployment information;
power level information;
SR pass-band configuration information and/or SR pass-band re-configuration information;
adjustment information;
gain control information and
filter information.

### Embodiment 17

The method according to any of the embodiments 12-16, further comprising:
providing repeater configuration information indicative of configuring the SR for the co-located DU function.

### Embodiment 18

The method according to any of the embodiments 12-17, wherein the second apparatus is a base station or a gNB of the radio network.

### Embodiment 19

An apparatus configured to perform and/or control or comprising respective means for performing and/or controlling the method of any of the embodiments 12 to 18.

### Embodiment 20

An apparatus comprising at least one processor and at least one memory including computer program code, the at least one memory and the computer program code configured to, with the at least one processor, cause an apparatus at least to perform and/or control the method of any of the embodiments 12 to 18.

### Embodiment 21

A system comprising:
at least one first apparatus according to any of the embodiments 10 and 11; and
at least one second apparatus according to any of the embodiments 19 and 20.

### Embodiment 22

A system comprising at least a first apparatus and a second apparatus, wherein the first apparatus comprises means configured to perform:
obtaining control information indicative of one or more control parameters for controlling a repeating of one or more signals of a cell of a serving node that is served by the first apparatus, wherein the control information is obtained from the serving node via a F1 interface established between a centralized unit, CU, of the serving node and a co-located distributed unit, DU, function on part of the first apparatus of a radio network; and
repeating the one or more signals of the cell between a respective UE of one or more UEs served by the cell and the serving node based at least in part of the control information;
   and wherein the second apparatus comprises means configured to perform:
providing control information indicative of one or more control parameters for controlling a repeating of one or more signals of a cell of the second apparatus that is served by a smart repeater, SR, wherein the control information is provided via a F1 interface established between a centralized unit, CU, of the second apparatus and a co-located distributed unit, DU, function on part of the SR of a radio network; and
sending and/or receiving one or more signals of the cell to and/or from the SR.

### Embodiment 23

A computer program comprising instructions or a computer readable medium comprising program instructions for causing an apparatus to perform at least the following:
obtaining control information indicative of one or more control parameters for controlling a repeating of one or more signals of a cell of a serving node that is served by the first apparatus, wherein the control information is obtained from the serving node via a F1 interface established between a centralized unit, CU, of the serving node and a co-located distributed unit, DU, function on part of the first apparatus of a radio network; and
repeating the one or more signals of the cell between a respective UE of one or more UEs served by the cell and the serving node based at least in part of the control information.

### Embodiment 24

A tangible computer-readable medium storing computer program code, the computer program code when executed by a processor causing an apparatus to perform and/or control:
obtaining control information indicative of one or more control parameters for controlling a repeating of one or more signals of a cell of a serving node that is served by the first apparatus, wherein the control information is obtained from the serving node via a F1 interface established between a centralized unit, CU, of the serving node and a co-located distributed unit, DU, function on part of the first apparatus of a radio network; and
repeating the one or more signals of the cell between a respective UE of one or more UEs served by the cell and the serving node based at least in part of the control information.

### Embodiment 25

A computer program comprising instructions or a computer readable medium comprising program instructions for causing an apparatus to perform at least the following:
providing control information indicative of one or more control parameters for controlling a repeating of one or more signals of a cell of the second apparatus that is served by a smart repeater, SR, wherein the control information is provided via a F1 interface established between a centralized unit, CU, of the second apparatus and a co-located distributed unit, DU, function on part of the SR of a radio network; and
sending and/or receiving one or more signals of the cell to and/or from the SR.

### Embodiment 26

A tangible computer-readable medium storing computer program code, the computer program code when executed by a processor causing an apparatus to perform and/or control:
providing control information indicative of one or more control parameters for controlling a repeating of one or more signals of a cell of the second apparatus that is served by a smart repeater, SR, wherein the control information is provided via a F1 interface established between a centralized unit, CU, of the second apparatus and a co-located distributed unit, DU, function on part of the SR of a radio network; and
sending and/or receiving one or more signals of the cell to and/or from the SR.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1-17. (canceled)

18. A first apparatus comprising at least one processor and at least one memory including computer program code, the at least one memory and the computer program code configured to, with the at least one processor, cause an apparatus at least to:
obtain control information indicative of one or more control parameters for controlling a repeating of one or more signals of a cell of a serving node that is served by the first apparatus, wherein the control information is obtained from the serving node via a F1 interface established between a centralized unit, CU, of the serving node and a co-located distributed unit, DU, function on part of the first apparatus of a radio network; and
repeat the one or more signals of the cell between a respective UE of one or more UEs served by the cell and the serving node based at least in part of the control information.

19. The first apparatus of claim 18, the first apparatus further being caused to:
provide a setup request message indicative of a DU capability of the first apparatus, wherein with the setup request message, a setup of the F1 interface is initiated; and
obtain a setup response message indicative of cell information that configure the first apparatus which one or more signals of the cell of the serving node are to be repeated.

20. The first apparatus according to claim 18, the first apparatus further being caused to:
provide a setup request message indicative of a DU capability of the first apparatus, wherein with the setup request message, a setup of the F1 interface is initiated; and
obtain a setup response message indicative of cell information that configure the first apparatus which one or more signals of the cell of the serving node are to be repeated, wherein the setup request message and/or the setup response message use radio resource control, RRC, signaling.

21. The first apparatus according to claim 18, wherein the F1 interface is a F1-control plane interface connection to the CU of the serving node.

22. The first apparatus according to claim 18, wherein the control information comprises one or more of the following information:
cell activity information;
network deployment information;
power level information;
SR pass-band configuration information and/or SR pass-band re-configuration information;
adjustment information;
gain control information; and
filter information.

23. The first apparatus according to claim 18, the first apparatus further being caused to:
obtain repeater configuration information indicative of configuring the first apparatus for the co-located DU function.

24. The first apparatus according to claim 18, wherein based on the control information, an amplify-and-forward, A/F, type repeating enabled by the first apparatus is controlled.

25. The first apparatus according to claim 18, wherein based on the control information, an amplify-and-forward, A/F, type repeating enabled by the first apparatus is controlled and wherein the A/F type repeating is controlled by an adjusting of a pass-band for one or more uplink and/or downlink signals of the one or more signals, an adjusting of an amplifier gain, a controlling of a filtering of the one or more signals, or a combination thereof.

26. The first apparatus according to claim 18, wherein the first apparatus is a smart repeater, and/or wherein the serving node is a base station or a gNB of the radio network.

27. A second apparatus, comprising at least one processor and at least one memory including computer program code, the at least one memory and the computer program code configured to, with the at least one processor, cause an apparatus at least to:
provide control information indicative of one or more control parameters for controlling a repeating of one or more signals of a cell of the second apparatus that is served by a smart repeater, SR, wherein the control information is provided via a F1 interface established between a centralized unit, CU, of the second apparatus and a co-located distributed unit, DU, function on part of the SR of a radio network; and
send and/or receiving one or more signals of the cell to and/or from the SR.

28. The second apparatus according to claim 27, the second apparatus further being caused to:
obtain a setup request message indicative of a DU capability of the SR, wherein with the setup request message, a setup of the F1 interface is initiated; and
provide a setup response message indicative of cell information that configure the SR which one or more signals of the cell of the second apparatus are to be repeated.

29. The second apparatus according to claim 27, wherein the setup request message and/or the setup response message use radio resource control, RRC, signaling.

30. The second apparatus according to claim 27, wherein the F1 interface is a F1-control plane interface connection to the SR.

31. The second apparatus according to claim 27, wherein the control information comprises one or more of the following information:
cell activity information;
network deployment information;
power level information;
SR pass-band configuration information and/or SR pass-band re-configuration information;
adjustment information;
gain control information and
filter information.

32. The second apparatus according to claim 27, the second apparatus further being caused to:
provide repeater configuration information indicative of configuring the SR for the co-located DU function.

33. The second apparatus according to claim 27, wherein the second apparatus is a base station or a gNB of the radio network.

34. A method, comprising:
obtaining, by a smart repeater, SR, of a radio network, control information indicative of one or more control parameters for controlling a repeating of one or more signals of a cell of a serving node of the radio network that is served by the SR, wherein the control information is obtained from the serving node via a F1 interface established between a centralized unit, CU, of the serving node and a co-located distributed unit, DU, function on part of the SR;
providing, by the serving node, control information indicative of one or more control parameters for controlling a repeating of one or more signals of the cell of the serving node, wherein the control information is provided via the F1 interface; and
sending and/or receiving, by the serving node, one or more signals of the cell to and/or from the SR; and repeating, by the SR, the one or more signals of the cell between a respective UE of one or more UEs served by the cell and the serving node based at least in part of the control information.
